(19) United States
(12) Patent Application Publication
(10) Pub. No.: US 2022/0345433 A1
(43) Pub. Date: Oct. 27, 2022

(54) DATA TRANSMISSION CIRCUIT

(71) Applicant: Chengdu Sino Microelectronics Technology Co.,Ltd., Chengdu (CN)

(72) Inventors: Guo LI, Chengdu (CN); Yuanjun CEN, Chengdu (CN); Can HU, Chengdu (CN); Wenyu ZANG, Chengdu (CN); Xiuhua XIE, Chengdu (CN)

(73) Assignee: Chengdu Sino Microelectronics Technology Co.,Ltd., Chengdu (CN)

(21) Appl. No.: 17/726,477

(22) Filed: Apr. 21, 2022

(30) Foreign Application Priority Data
Apr. 22, 2021 (CN) 202110437721.9

(51) Int. Cl. H04L 51/226; H04L 47/24; H04L 47/62

(52) U.S. Cl. CPC H04L 51/226; H04L 47/24; H04L 47/6215

(57) ABSTRACT

A data transmission circuit includes a data sending module and a data receiving module. The data sending module includes a message identification unit, used for sending messages to corresponding encapsulation units according to a priority of message data to be sent; a low-priority message encapsulation unit, used for slicing low-priority messages, encapsulating message slices respectively to form low-priority message slice packets, and then sending the low-priority message slice packets to a low-priority sending queue; a high-priority message encapsulation unit, used for encapsulating high-priority messages to form high-priority message packets and then sending the high-priority message packets to a high-priority sending queue; and a message sending unit, used for sending message packets in the high-priority sending queue and the low-priority sending queue, and preferentially processing the high-priority sending queue. The data receiving module includes a message parsing and distributing unit, a low-priority message receiving unit, and a high-priority message receiving unit.

### CROSS REFERENCE TO THE RELATED APPLICATIONS

This application is based upon and claims priority to Chinese Patent Application No. 202110437721.9, filed on Apr. 22, 2021, the entire contents of which are incorporated herein by reference.

### TECHNICAL FIELD

The present invention relates to a communication technology and an integrated circuit technology.

### BACKGROUND

Due to the characteristics of artificial intelligence algorithms, a large amount of data needs to be transmitted in artificial intelligence chips. Generally speaking, using NoC (Network-on-Chip) is a relatively common method. In NoC, transmitted data can be divided into different services according to different types of transmitted data. Various service messages share a transmission network bandwidth. In a transmission network, services will be divided into two types of a delay-sensitive service and a delay-insensitive service. The delay-sensitive service is called a high-priority service, and the delay-insensitive service is called a low-priority service. Due to the diversity of services, the lengths of messages are also different. On a shared transmission node, there may be low-priority long messages that block high-priority short messages, resulting in increasing of the transmission delay of high-priority messages.

### SUMMARY

The technical problem to be solved by the present invention is to provide a data transmission method and a data transmission circuit, which can properly solve the problem of delay of high-priority data.

The second technical problem to be solved by the present invention is to provide an artificial intelligence chip with a faster processing speed.

The technical solution adopted by the present invention to solve the technical problem is as follows.

The present invention provides a data transmission circuit, including a data sending module and a data receiving module, wherein

the data sending module includes the following parts:

a message identification unit, used for sending messages to corresponding encapsulation units according to a priority of message data to be sent;

a low-priority message encapsulation unit, used for slicing low-priority messages, encapsulating message slices respectively to form low-priority message slice packets, and then sending the low-priority message slice packets to a low-priority sending queue;

a high-priority message encapsulation unit, used for encapsulating high-priority messages to form high-priority message packets and then sending the high-priority message packets to a high-priority sending queue; and

a message sending unit, used for sending message packets in the high-priority sending queue and the low-priority sending queue, and preferentially processing the high-priority sending queue;

the data receiving module includes:

a message parsing and distributing unit, used for decapsulating received message packets, and sending the message packets to corresponding message processing units according to a priority of the messages;

a low-priority message receiving unit, used for receiving decapsulated low-priority message slices, and recombining and restoring the low-priority message slices to the low-priority messages; and

a high-priority message receiving unit, used for receiving decapsulated high-priority messages.

the data sending module further includes a priority labeling unit for labeling priority information of message packets.

A working method of the data transmission circuit of the present invention includes the following steps:

a, identifying, by a sender, a priority of a message to be sent, if the message to be sent is of a high priority, encapsulating the message to be sent and then sending the message to be sent to a high-priority sending queue and proceeding Step c, and if the message to be sent is of a low priority, proceeding Step b;

b, slicing a low-priority message, and then encapsulating slices one by one and then sending the slices to a low-priority sending queue, and proceeding Step c;

c, preferentially sending a message packet in the high-priority sending queue; and

d, classifying, by a receiver, a received message according to encapsulation information thereof, if the received message is of a high priority, sending the received message to the high-priority queue, and if the received message is of a low priority, sending the received message to the low-priority queue for recombination.

The present invention has the following beneficial effects that the blocking of a high-priority message by a low-priority message is significantly reduced, the transmission speed of the high-priority message is ensured, and the present invention is applied to the artificial intelligence chip, improving the key processing speed of the chip.

### BRIEF DESCRIPTION OF THE DRAWINGS

FIG. 1 is a schematic diagram of blocking delay of high and low priority messages.

FIG. 2 is a schematic diagram of a method of the present invention.

FIG. 3 is a schematic diagram of results at different rates under 9600 Bytes.

FIG. 4 is a schematic diagram of results at different packet lengths under 50 Mbps.

FIG. 5 is a schematic diagram of an architecture of a sending side.

FIG. 6 is a schematic diagram of an architecture of a receiving side.

FIG. 7 is a schematic diagram of a frame header synchronization state machine of the receiving side.

### DETAILED DESCRIPTION OF THE EMBODIMENTS

The main point of the present invention is to slice low-priority messages at a scheduling moment to reduce the blocking time of high-priority messages.

A data transmission method of the present invention includes the following steps:

a, identifying, by a sender, a priority of a message to be sent, if the message to be sent is of a high priority, encapsulating the message to be sent and then sending the message to be sent to a high-priority sending queue and proceeding Step c, and if the message to be sent is of a low priority, proceeding Step b;

b, slicing a low-priority message, and then encapsulating slices one by one and then sending the slices to a low-priority sending queue, and proceeding Step c;

c, preferentially sending a message packet in the high-priority sending queue; and

d, classifying, by a receiver, a received message according to encapsulation information thereof, if the received message is of a high priority, sending the received message to the high-priority queue, and if the received message is of a low priority, sending the received message to the low-priority queue for recombination.

The present invention further provides a data transmission circuit, including a data sending module and a data receiving module, wherein the data sending module includes the following parts:

a message identification unit, used for sending messages to corresponding encapsulation units according to a priority of message data to be sent;

a low-priority message encapsulation unit, used for slicing low-priority messages, encapsulating message slices respectively, and then sending the message slices to a low-priority sending queue;

a high-priority message encapsulation unit, used for encapsulating high-priority messages and then sending the high-priority messages to a high-priority sending queue; and

a message sending unit, used for sending messages in the high-priority sending queue and the low-priority sending queue, and preferentially processing the high-priority sending queue;

the data receiving module includes:

a message parsing and distributing unit, used for decapsulating received messages, and sending the messages to corresponding message processing units according to a priority of the messages;

a low-priority message receiving unit, used for receiving decapsulated low-priority message slices, and recombining and restoring the slices; and

a high-priority message receiving unit, used for receiving decapsulated high-priority messages.

The present invention further provides an artificial intelligence chip with the above data transmission circuit.

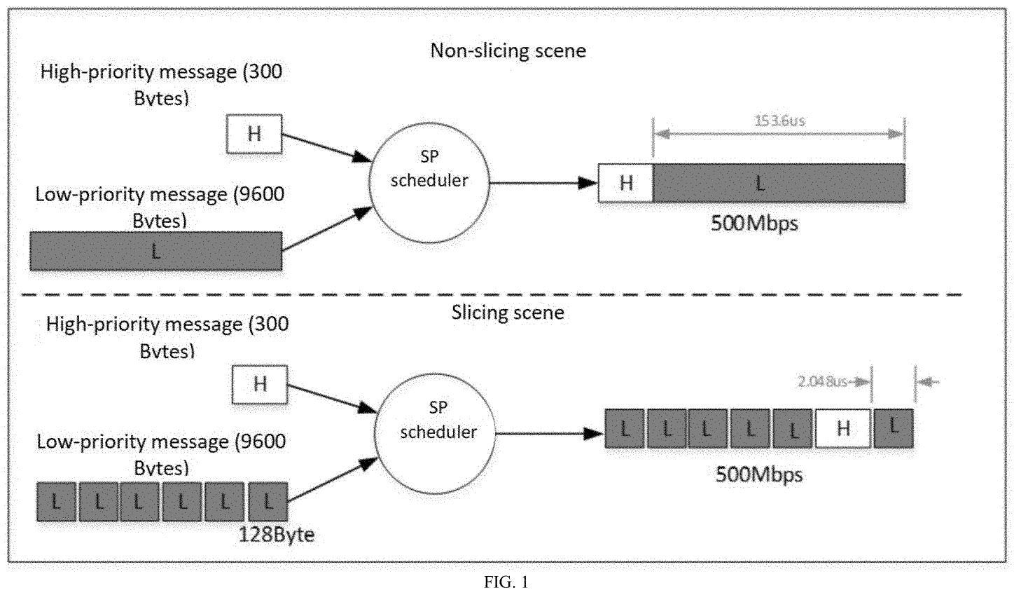

FIG. 1 shows a scene without slicing. Assuming that a network transmission bandwidth is 500 Mbps, if a low-priority message arrives at a scheduler 1 ns earlier than a high-priority message, it will be scheduled first. At this time, the high-priority message needs to wait for completion of transmission of the low-priority message selected by scheduling before it can be scheduled for transmission. A 9600 Byte low-priority message needs to take 153.6 us to complete transmission under a 500 Mbps transmission band, which means that the high-priority message will be blocked for 153.6 us.

### Embodiment 1

In this embodiment, a low-priority message with a relatively long length is sliced at a granularity of 128 Bytes, and in this scene, a high-priority message is blocked for a transmission time of at most 128 Byte message, namely 2.048 us. Therefore, adopting a slice mode to transmit the low-priority message can greatly reduce blocking of the high-priority message by the low-priority message.

After a slicing technology is adopted, in order to ensure that the two communicating parties can correctly identify a location of a slice in an original message, it is necessary to mark relevant information (such as locations, serial numbers, etc.) in a data structure of an encapsulation header, so that a sliced message can be recombined on a receiver.

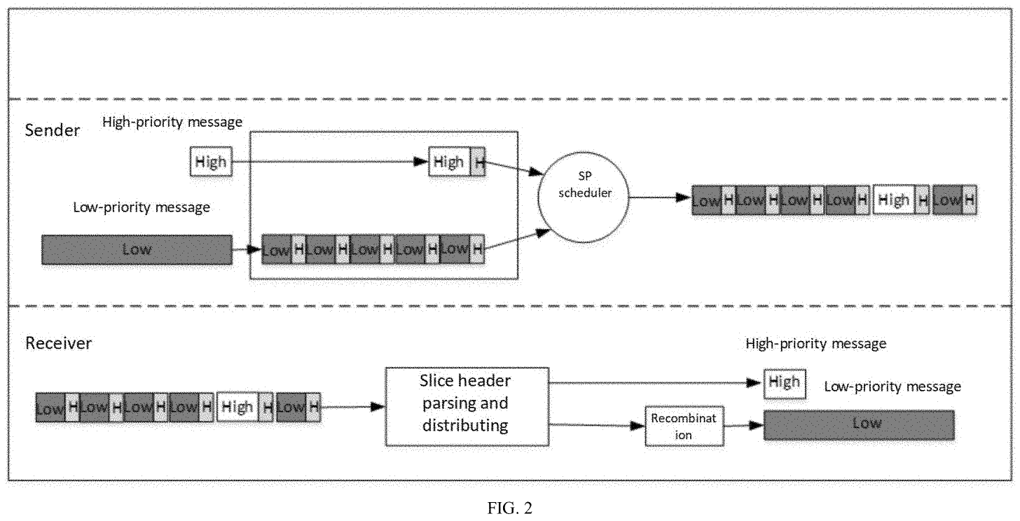

As shown in FIG. 2, in this embodiment, the low-priority message is sliced on a sender, and slice headers (data packet headers) are encapsulated and then scheduled, wherein a length of a slice header for the low-priority message is 4 Bytes, and a length of a data packet header for the high-priority message is 2 Bytes.

On a data receiver, after messages are synchronized according to data formats of message data packet headers, the data packet headers are parsed and distributed to a high-priority queue and a low-priority queue respectively according to priority indications, and messages in the low-priority queue are recombined.

Data structures of high-priority message encapsulation headers (namely data packet headers) are shown in Table 1.

TABLE 1

| | | | | | | | |
|---|---|---|---|---|---|---|---|
| Bit7 | Bit6 | Bit5 | Bit4 | Bit3 | Bit2 | Bit1 | Bit0 |

SYNC_HED

| | |
|---|---|
| RES | PRI |

| | |
|---|---|
| Domain | Instructions |
| names | |
| SYNC_HED | Sync header, defaulted as 10100101 |
| PRI | High and low priority indications: |
| | 0: Low priority |
| | 1: High priority |

Data structures of low-priority message slice encapsulation headers (data packet headers) are shown in Table 2.

TABLE 2

| | | | | | | | |
|---|---|---|---|---|---|---|---|
| Bit7 | Bit6 | Bit5 | Bit4 | Bit3 | Bit2 | Bit1 | Bit0 |

SYNC_HED

| | | | |
|---|---|---|---|
| RES | SEG | RES | PRI |

SN
LEN

| | |
|---|---|
| Domain | Instructions |
| names | |
| SYNC_HED | Sync header, defaulted as 10100101 |
| PRI | High and low priority indications: |
| | 0: Low priority |
| | 1: High priority |
| SEG | A location of a slice in an original message: |
| | 00: A length of the original message is |
| | greater than 128, this slice is an original |
| | message head slice |
| | 01: A length of the original message is |
| | greater than 128, this slice is an original |
| | message middle slice |
| | 10: A length of the original message is |
| | greater than 128, this slice is an original |
| | message tail slice |
| | 11: A length of the original message is |
| | less than 128, this slice |
| | includes all messages |
| SN | Serial numbers of message slices |
| LEN | Lengths of messages after slicing |

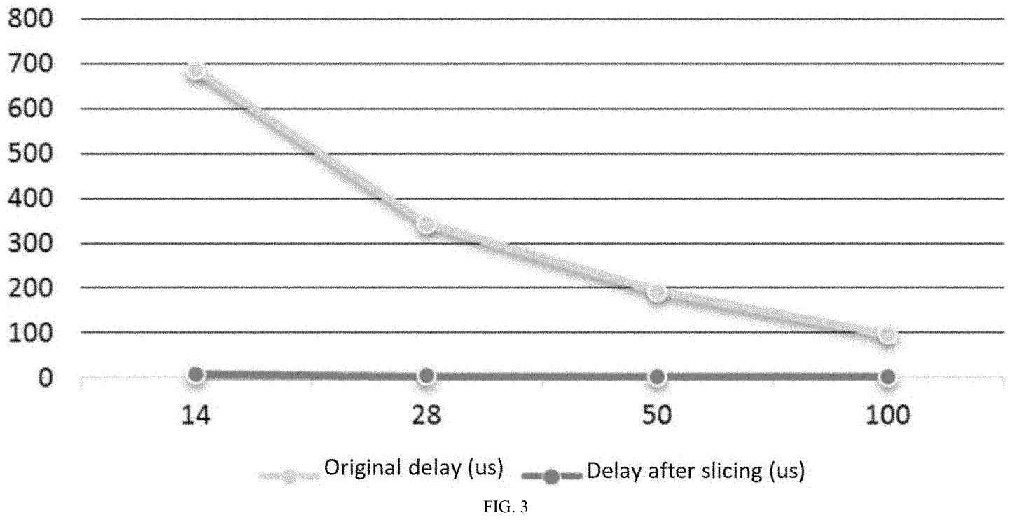

For a scene with a low-priority packet length of 9600, under 14 Mbps, 28 Mbps, 50 Mbps, and 100 Mbps scenes, the difference between a non-slicing solution and a slicing solution in blocking transmission delay of the high-priority message by the low-priority message is shown in FIG. 3. Test results show that under a highest 100 Mbps scene, there is still a delay benefit of 100 us after slicing.

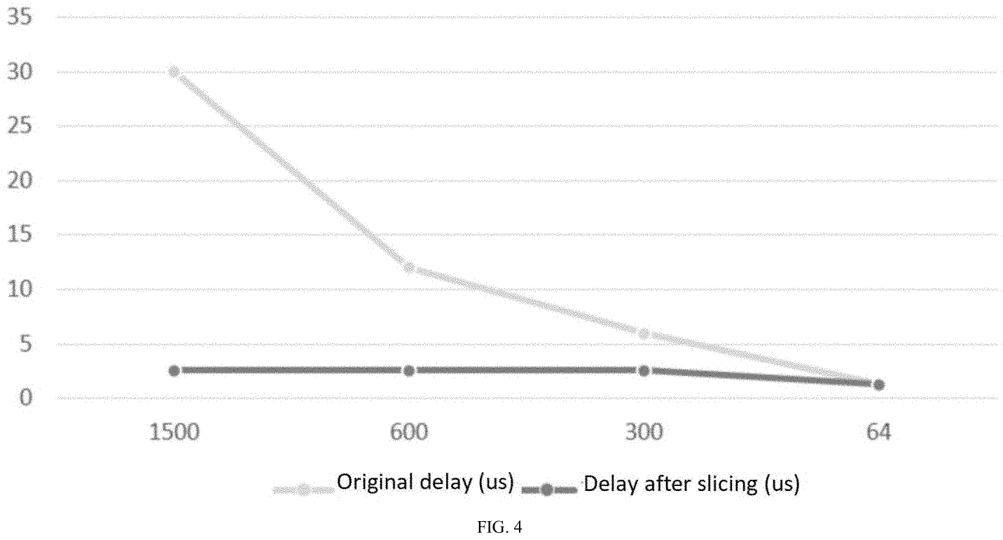

By considering a typical transmission rate of 50 Mbps, under 1500 Byte, 600 Byte, 300 Byte and 64 Byte scenes, the difference between a non-slicing solution and a slicing solution in blocking transmission delay of the high-priority message by the low-priority message is shown in FIG. 4. Under a highest 64 Byte scene, there is no difference between slicing and non-slicing. Under a 300 Byte scene, there is still a delay benefit of 4 us.

### Embodiment 2

This embodiment provides more specific technical details.

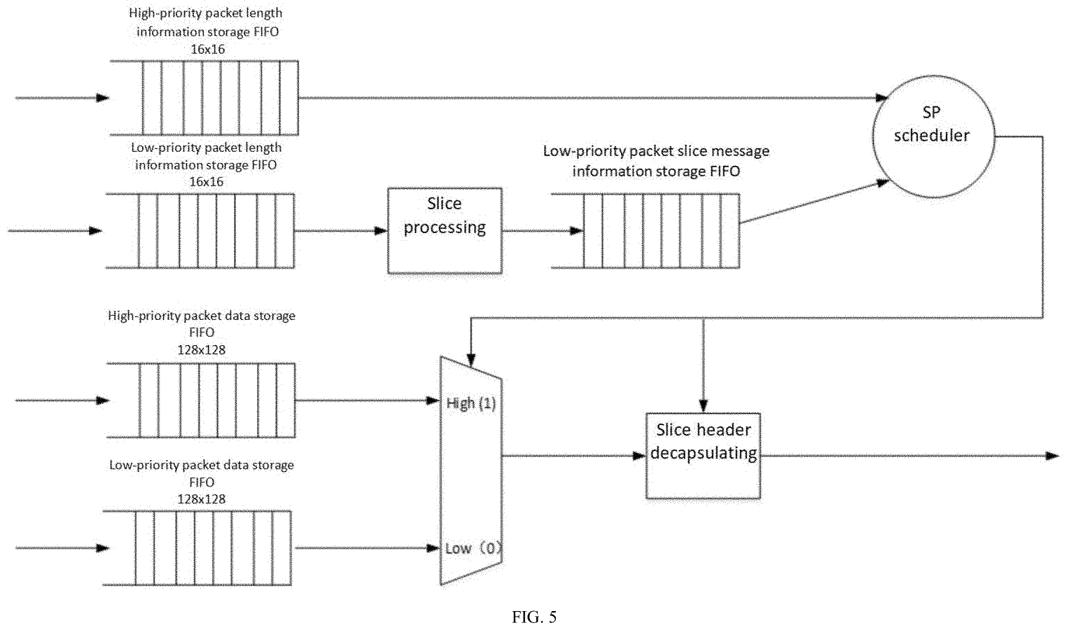

An overall implementation of a sending side is shown in FIG. 5. After entering a sender (a sending side), messages enter high and low priority queues respectively according to high and low priority attributes, which is implemented through high and low priority FIFO. While data are stored, length information of high and low priority messages is recorded in two independent length information FIFO queues respectively. High-priority messages can directly participate in scheduling. Low-priority messages need to be sliced before they can participate in scheduling. The scheduling adopts an SP (absolute priority) mode, that is, as long as there are high-priority messages, the high-priority messages are scheduled for dequeuing. After the scheduling is completed, according to scheduling results, high-priority or low-priority message data are selected for dequeuing, and meanwhile, dequeued messages are encapsulated and then sent out.

Slice processing is recorded by a slice_len_cnt accumulator. After length information pkt_len of a packet is read from the low-priority packet length information FIFO, it is assigned to slice_len_cnt as an initial value, then a 128 is subtracted in each Cycle until the length is less than 128, and meanwhile, corresponding slice encapsulation header information is generated. Corresponding RTL implementation is as follows:

```
always @(posedge clk_sys or negedge rst_sys_n) begin
  if (rst_sys_n == I'b0) begin
    slice_len_cnt <= {PKT_LEN{l'b0}};
    slice_seg  <= 2'b00;
    slice_sn  <= 8'h0;
  end
  else if (cnt_strt == 1'b1) begin
    slice_len_cnt <= pkt_len;
    if (pkt_len <= 8'd128) begin
      slice_seg <= 2'b11;
    end
    else begin
      slice_seg <= 2'b00;
    end
    slice_sn  <= 8'h0;
  end
  else if (slice_len_cnt > 8’d128) begin
    slice_len_cnt <= slice_len_cnt − 8'd128;
    slice_seg <= 2'b01;
    slice_sn <= slice_sn + 1'b1;
  end
  else begin
    slice_seg <= 2'b10;
  end
end
```

Slice header encapsulation: according to attributes of messages, high-priority or low-priority slice header encapsulation is performed on the messages. Since encapsulation headers are data added on the basis of an original message, it is necessary to splicing transmission data, which is completed by adopting a shift register mode. RTL implementation thereof is as follows:

```
always @(posedge clk_sys or negedge rst_sys_n) begin
  if (rst_sys_n == 1'b0) begin
    pkt_data_out <= {PKT_WIDTH{1'b0}};
  end
  else if (pkt_send_strt == 1'b1) begin
  if (pkt_pri == HIGH) begin
    pkt_data_out <= {pkt_data_in [PKT_WIDTH-16-1: 0],
        {{7{l'b0}}, HIGH},
        sync_hed};
  end
  else begin
    pkt_data_out <= {pkt_data_in [PKT_WIDTH-32-1: 0],
        slice_len,
        slice_sn,
        {2{l'b0}}, slice_seg, {{3{l'b0}}, LOW},
        sync_hed};
    end
  end
  else if (pkt_send == 1'bl) begin
    if (pkt_pri == HIGH) begin
      pkt_data_out <= {pkt_data_in [PKT_WIDTH-16-1: 0],
        pkt_data_in_1d [PKT_WIDTH-l -: 16]};
    end
    else begin
      pkt_data_out <= {pkt_data_in [PKT_WIDTH-32-1: 0],
        pkt_data_in_1d [PKT_WIDTH-l -: 32]};
    end
  end
end
```

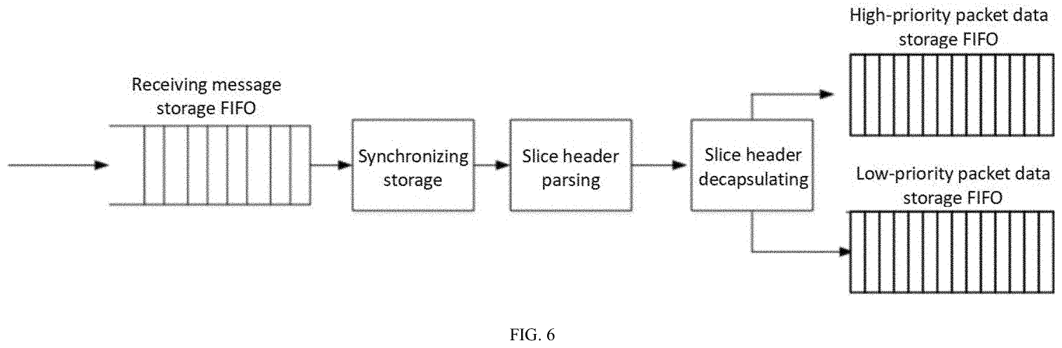

An overall implementation of a receiving side is shown in FIG. 6. After entering a sending side module, messages first enter queues and wait for processing. First, received messages are synchronized. After synchronization of 3 messages is completed, a synchronization state is truly entered. After the synchronization is completed, a data packet header is parsed to obtain slice related information.

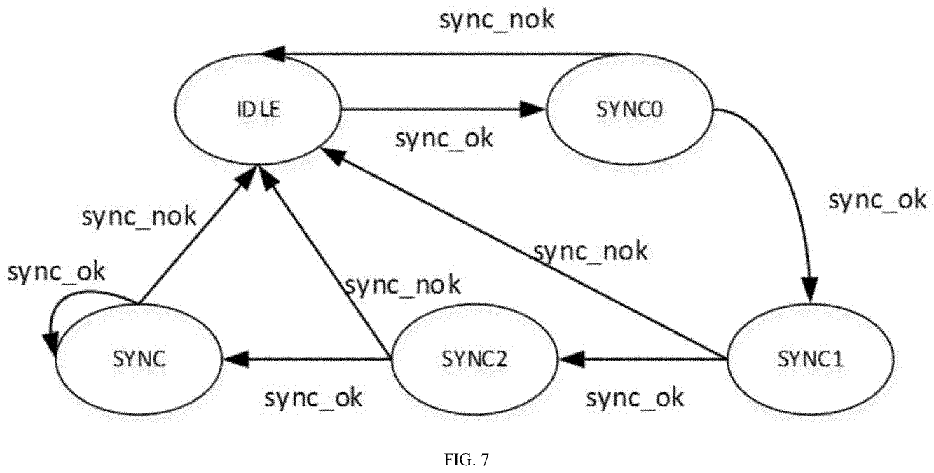

Synchronization processing is completed through a state machine, as shown in FIG. 7. It is necessary to complete the synchronization of 3 messages before it is determined to enter the synchronization state. Meanwhile, it is in the synchronization state, that is, a synchronization header is checked in each slice. If there is a loss of synchronization, re-synchronization needs to be performed.

RTL implementation generated by sync header correct sync_ok signals and sync header loss-of-synchronization sync_nok is as follows:

```
always @(posedge clk_sys or negedge rst_sys_n) begin
  if (rst_sys_n == 1'b0) begin
    sync_ok <= 1'b0;
    sync_nok <= 1'b0;
  end
  else if (sync_vld == 1'b1) begin
    if (pkt_rec_in [7:0] == 8'hA5) begin
      sync_ok <= 1'b1;
      sync_nok <= 1'b0;
    end
    else begin
      sync_ok <= 1'b0;
      sync_nok <= 1'b1;
    end
  end
  else begin
    sync_ok <= 1'b0;
    sync_nok <= 1'b0;
  end
end
```

Data packet header parsing of slices: parsing of slice header domain information pri, seg, sn, len is mainly completed, and RTL code implementation thereof is as follows:

```
always @(posedge clk_sys or negedge rst_sys_n) begin
  if (rst_sys_n == 1'b0) begin
    slice_rec_pri  <= 1'b0;
    slice_rec_seg  <= 2'b00;
    slice_rec_sn  <= 8'h0;
    slice_rec_len  <= 8'h0;
  end
  else if (sync_vld == 1'b1 && sync_fsm_cur_st == SYNC) begin
    slice_rec_pri  <= pkt_rec_in [8];
    slice_rec_seg  <= pkt_rec_in [13:12];
    slice_rec_sn  <= pkt_rec_in [23:16];
    slice_rec_len  <= pkt_rec_in [31:24];
  end
end
```

Slice data packets are decapsulated to complete stripping of slice headers and reorganization of data, and RTL code implementation thereof is as follows:

```
always @(posedge clk_sys or negedge rst_sys_n) begin
  if (rst_sys_n == 1'b0) begin
    pkt_rec_out <= {PKT_WIDTH{1'b0} };
  end
  else if (sync_fsm_cur_st == SYNC) begin
    if (slice_rec_pri == HIGH) begin
      pkt_rec_out <= {pkt_rec_in [15: 0],
        pkt_rec_in_1d[PKT_WIDTH-1:16]};
    end
    else begin
      pkt_rec_out <= {pkt_rec_in [31: 0],
        pkt_rec_in_1d[PKT_WIDTH-l: 32]};
    end
  end
end
```

The specification has fully explained the necessary technical content of the present invention, and those of ordinary skill in the art can fully implement it accordingly, and more detailed technical details will not be repeated.

What is claimed is:

1. A data transmission circuit, comprising a data sending module and a data receiving module, wherein
the data sending module comprises:
a message identification unit, used for sending messages to corresponding encapsulation units according to a priority of message data to be sent;
a low-priority message encapsulation unit, used for slicing low-priority messages, encapsulating message slices respectively to form low-priority message slice packets, and then sending the low-priority message slice packets to a low-priority sending queue;
a high-priority message encapsulation unit, used for encapsulating high-priority messages to form high-priority message packets and then sending the high-priority message packets to a high-priority sending queue; and
a message sending unit, used for sending message packets in the high-priority sending queue and the low-priority sending queue, and preferentially processing the high-priority sending queue;
the data receiving module comprises:
a message parsing and distributing unit, used for decapsulating received message packets, and sending the message packets to corresponding message processing units according to a priority of the messages;
a low-priority message receiving unit, used for receiving decapsulated low-priority message slices, and recombining and restoring the decapsulated low-priority message slices to the low-priority messages; and
a high-priority message receiving unit, used for receiving decapsulated high-priority messages.

2. The data transmission circuit as claimed in claim 1, wherein the data sending module further comprises a priority labeling unit for labeling priority information of message packets.

3. The data transmission circuit as claimed in claim 1, wherein a working method of the data transmission circuit comprises:
step a: identifying, by a sender, a priority of a message to be sent, when the message to be sent is of a high priority, encapsulating the message to be sent and then sending the message to be sent to a high-priority sending queue and proceeding step c, and when the message to be sent is of a low priority, proceeding step b;
step b: slicing a low-priority message, and then encapsulating slices one by one and then sending the slices to a low-priority sending queue, and proceeding step c;
step c: preferentially sending a message packet in the high-priority sending queue; and
step d: classifying, by a receiver, a received message according to encapsulation information of the received message, when the received message is of the high priority, sending the received message to a high-priority queue, and when the received message is of the low priority, sending the received message to a low-priority queue for recombination.
